(19) United States
(12) Patent Application Publication
(10) Pub. No.: US 2026/0014817 A1
(43) Pub. Date: Jan. 15, 2026

(54) DUAL WHEEL CENTERING APPARATUS AND METHOD

(71) Applicant: Codey Saville, Lloydminster (CA)

(72) Inventor: Codey Saville, Lloydminster (CA)

(21) Appl. No.: 19/266,038

(22) Filed: Jul. 10, 2025

Related U.S. Application Data
(60) Provisional application No. 63/669,284, filed on Jul. 10, 2024.

(51) Int. Cl. B60B 29/00

(52) U.S. Cl. CPC B60B 29/001

(57) ABSTRACT

The present disclosure provides a wheel centering apparatus and sleeve comprising a cylindrical body extending from a first end to a second end, a threaded hole extending into the first end configured to engage with a wheel stud, a junction interface extending from the second end having a non-circular cross-section, and longitudinal indicator markings along the cylindrical body. The apparatus facilitates centering and alignment of dual wheels on an axle. A method of using two such apparatuses for centering dual wheels is also disclosed, along with a system incorporating the apparatuses and a level for wheel alignment.

### CROSS-REFERENCE TO RELATED APPLICATIONS

This application claims priority to U.S. Provisional Patent Application No. 63/669,284, titled Dual Wheel-Centering Apparatus and Method, filed Jul. 10, 2024, which is hereby incorporated by reference in its entirety.

### FIELD

The present disclosure relates to vehicle wheel centering and alignment, and more particularly to a dual wheel centering apparatus and method for centering and aligning wheels in dual tire configurations, single wheel configurations, and wheels that are hub piloted or stud piloted systems commonly found on heavy-duty vehicles.

### BACKGROUND

Wheel alignment and centering play crucial roles in the performance, safety, and longevity of vehicles, particularly for heavy-duty vehicles utilizing dual tire (hub and/or stud piloted) configurations. Proper wheel alignment ensures that the wheels are perpendicular to the ground and parallel to each other, which affects vehicle handling, tire wear, and fuel efficiency. In dual tire (hub and/or stud piloted) setups, commonly found on trucks, trailers, and other commercial vehicles (utilizing rolling, lift, tag axles, etc.), the centering of both the inner and outer wheels is essential for balanced weight distribution and optimal performance.

Traditionally, wheel alignment procedures have focused on adjusting camber, caster, and toe angles to meet manufacturer specifications. However, these methods often do not address the root cause of the specific challenges presented by dual wheel assemblies. The alignment of dual wheels requires precision in both the individual wheel alignment and the relative positioning of the inner and outer wheels to each other.

Existing wheel centering techniques for single wheels typically involve the use of cone-shaped adapters or clamps that attach to the wheel rim. These methods, while effective for single wheel configurations, may not adequately address the complexities of dual wheel setups. The presence of two wheels mounted side by side introduces additional variables that can affect overall vehicle performance if not properly accounted for during the alignment process.

The process of mounting and aligning dual wheels can be time-consuming and physically demanding. Technicians often struggle with the weight and bulk of the wheels, particularly when trying to align both the inner and outer wheels simultaneously. This can lead to inefficiencies in service operations and potential safety concerns for the technicians involved.

Furthermore, the increasing diversity of wheel and tire combinations in the commercial vehicle market has created a need for more versatile and adaptable alignment tools. Different vehicles may have varying stud patterns, wheel offsets, and tire sizes, requiring alignment equipment that can accommodate these differences while maintaining accuracy and ease of use, and such equipment often is poorly modified, inaccurate, and/or unsafe.

Advancements in wheel alignment technology have introduced laser and camera-based systems that offer high precision measurements. However, these systems often come with significant costs and inefficiencies and may require specialized training to operate effectively. Without proper training, such systems may be misused and can potentially cause problems such as cupped or flat-spotted wheels. There remains a need for simpler, more cost-effective solutions that can provide accurate centering and alignment for dual wheel configurations across a wide range of vehicle wheel configurations across a wide range of vehicle types.

As vehicles continue to evolve, with trends towards larger wheels and more complex suspension with trends towards larger wheels and more complex suspension systems, the importance of precise wheel alignment and centering becomes increasingly apparent. Improve becomes increasingly apparent. Improved methods and tools for dual wheeld methods and tools for dual wheel alignment could potentially lead to enhanced vehicle stability and longevity, reduced tire wear, improved fuel efficiency, and ultimately, safer operation of heavy-duty vehicles on the road.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a wheel centering apparatus is provided. The wheel centering apparatus includes a cylindrical body extending from a first end to a second end. A threaded hole extends into the first end, and a sleeve may be configured on the first end, the threaded hole and sleeve configured to engage with a wheel stud. A junction interface extends from the second end, having a non-circular cross-section. The apparatus also includes longitudinal markings along the cylindrical body.

According to other aspects of the present disclosure, the wheel centering apparatus may include one or more of the following features. The junction interface may have a hexagonal cross-section configured to engage a socket. The longitudinal markings may be dispersed at equal intervals along the cylindrical body. The apparatus may further comprise a planar side extending from the first end to the second end. The planar side may be configured to provide a surface for resting a level. A level may be magnetic and comprised of polymers, or made of any materials including steel, magnetic metals, and non-magnetic material. The cylindrical body may be made of a corrosion-resistant material. The corrosion-resistant material may be stainless steel, plastic, or any material that is durable and consistent.

According to another aspect of the present disclosure, a method of centering dual wheels on an axle is provided. The method includes attaching a first wheel centering apparatus to a first wheel stud and a second wheel centering apparatus to a second wheel stud on opposite sides of a wheel hub. An inner wheel is slid onto the first and second wheel centering apparatuses. An outer wheel is slid onto the first and second wheel centering apparatuses. The inner and outer wheels are partially secured by snugging existing wheel bolts or nuts before removing the first and second wheel centering apparatuses. Two or more bolts or nuts can be snugged to hold wheels in place while tools are removed, and can be implemented on or off by hand, wrench, socket, electric or pneumatic tools, any other form of power or manual installation and removal.

According to other aspects of the present disclosure, the method may include one or more of the following features. The method may further comprise using the first and second wheel centering apparatuses in conjunction with level indicator marks to adjust wheel camber and toe alignment prior to sliding the inner wheel onto the first and second wheel centering apparatuses. The level may be an integrated digital level within each of the first and second wheel centering apparatuses. The integrated digital level may include a wireless communication module for transmitting alignment data to an external device. Attaching the first and second wheel centering apparatuses may comprise threading each apparatus onto its respective wheel stud. The method may further comprise, after partially securing the inner and outer wheels, removing the first and second wheel centering apparatuses, and fully securing the inner and outer wheels by fastening bolts or nuts to the first and second wheel studs. The first and second wheel centering apparatuses may each comprise a junction interface with a hexagonal cross-section, and removing the first and second wheel centering apparatuses may comprise engaging the junction interface with a socket tool.

According to another aspect of the present disclosure, a system for aligning dual wheels is provided. The system includes two wheel centering apparatuses, each having a cylindrical body with longitudinal indicator markings placed, for example, every 1/16^{th} inch, a threaded hole at a first end, and a junction interface with a non-circular cross-section at a second end. The embodiments of the present invention may utilize any desired measurement system. The system also includes a level configured to rest on the two wheel centering apparatuses when installed on wheel studs.

According to other aspects of the present disclosure, the system may include one or more of the following features. Each wheel centering apparatus may further comprise a planar side extending from the first end to the second end, configured to provide a surface for resting the level. The level may be a digital level with a display showing a current angle measurement. The digital level may include a wireless communication module for transmitting alignment data to an external device. The system may further comprise a software application on the external device for analyzing and displaying the alignment data. Each wheel centering apparatus may include an adjustable length mechanism to accommodate various wheel sizes.

The foregoing general description of the illustrative embodiments and the following detailed description thereof are merely exemplary aspects of the teachings of this disclosure and are not restrictive.

### BRIEF DESCRIPTION OF THE DRAWINGS

Non-limiting and non-exhaustive examples are described with reference to the following figures.

FIG. 1 illustrates a perspective view of a wheel centering apparatus, according to aspects of the present disclosure.

FIG. 2 shows a close-up view of a portion of the wheel centering apparatus, according to an embodiment of the present invention.

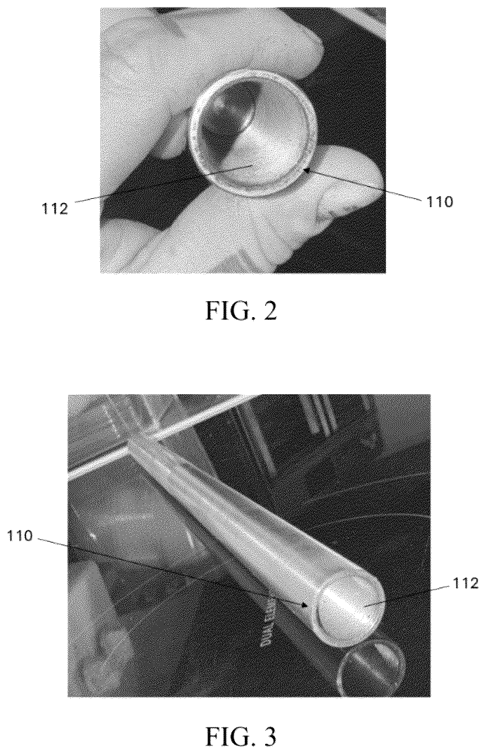

FIG. 3 depicts a detailed view of a threaded hole in the wheel centering apparatus, according to aspects of the present disclosure.

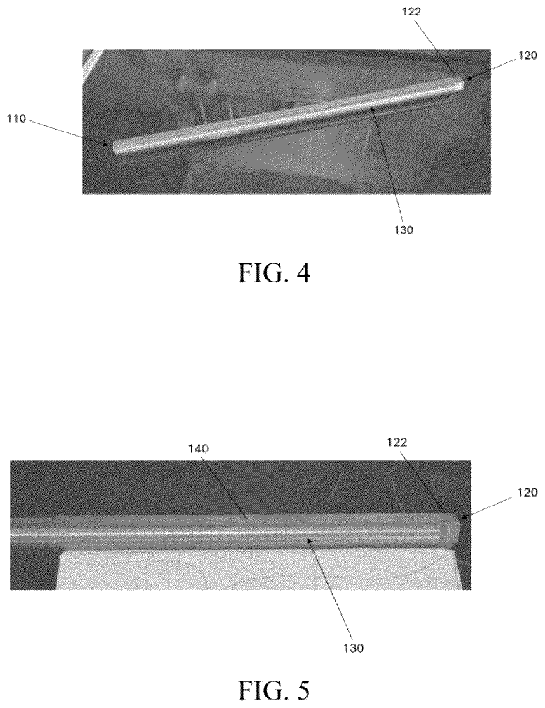

FIG. 4 and FIG. 5 show side views of the wheel centering apparatus, according to an embodiment of the present invention.

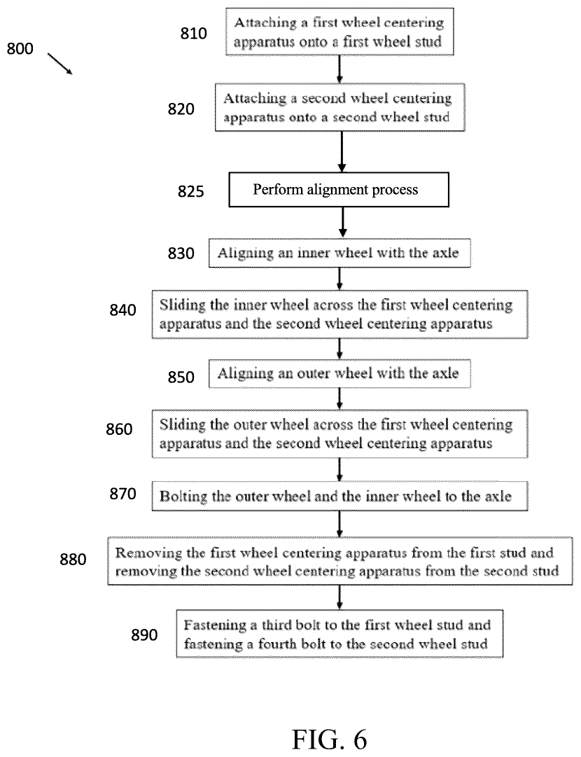

FIG. 6 illustrates a flowchart depicting a method for centering dual tire configurations, according to aspects of the present disclosure.

FIG. 7 depicts a perspective view of wheel centering apparatuses mounted on an axle, according to an embodiment of the present invention.

FIG. 8 shows an orthogonal view of a wheel alignment setup using centering apparatuses, according to aspects of the present disclosure.

FIG. 9 depicts a focused view of a level used with a wheel centering apparatus comprising a planar surface, according to an embodiment of the present invention.

FIG. 10 illustrates a perspective view of an inner wheel installation onto an axle, according to aspects of the present disclosure.

FIG. 11 shows a front view of a dual wheel setup mounted on an axle, according to an embodiment of the present invention.

FIG. 12 depicts a focused perspective view of a dual wheel setup on an axle, according to aspects of the present disclosure.

FIG. 13 illustrates an orthogonal view of a dual wheel assembly mounted on an axle, according to an embodiment of the present invention.

FIGS. 14 and 15 show perspective views of a wheel centering apparatus sleeve, according to an embodiment of the invention.

FIG. 16 depicts a perspective view of a drive axle wheel centering apparatus, according to an embodiment of the present invention.

FIG. 17 depicts a side perspective view of a threaded hole at an end of a drive axle wheel centering apparatus, according to an embodiment of the present invention.

FIG. 18 depicts a focused perspective view of a drive axle wheel centering apparatus, according to an embodiment of the present invention.

FIG. 19 depicts a perspective view of a steer axle wheel centering apparatus, according to an embodiment of the present invention.

FIG. 20 depicts a perspective view of a complete set of wheel centering apparatus tools, according to an embodiment of the present invention.

### DETAILED DESCRIPTION OF EMBODIMENTS OF THE INVENTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure relates to wheel centering apparatuses and methods for centering dual tire (hub and/or stud piloted) configurations on vehicle axles. Wheel centering plays a crucial role in ensuring proper alignment, stability, and performance of vehicles, particularly those with dual tire setups commonly found in heavy-duty trucks, trailers, and certain pickup trucks.

Dual tire configurations present unique challenges in wheel alignment and centering due to the presence of two wheels mounted side-by-side on each axle end. Proper centering of both the inner and outer wheels is essential for even weight distribution, uniform tire wear, and optimal vehicle handling. Misaligned or improperly centered wheels may lead to various issues, including uneven tire wear, reduced fuel efficiency, and compromised vehicle stability.

The wheel centering apparatus and method described herein address these challenges by providing a means to accurately center both the inner and outer wheels of a dual tire configuration simultaneously. This approach may offer advantages over traditional centering methods that focus on individual wheels, improving the overall alignment process and resulting in more precise wheel positioning.

In some cases, the wheel centering apparatus may be used in conjunction with existing alignment tools and techniques to enhance the overall wheel alignment process. The apparatus and method may be applicable to various types of vehicles that utilize dual tire configurations, including but not limited to commercial trucks, trailers, and heavy-duty pickup trucks.

The following detailed description provides further information on the structure, functionality, and implementation of the wheel centering apparatus and method. Various embodiments and configurations may be possible, and the specific examples provided should not be construed as limiting the scope of the disclosure.

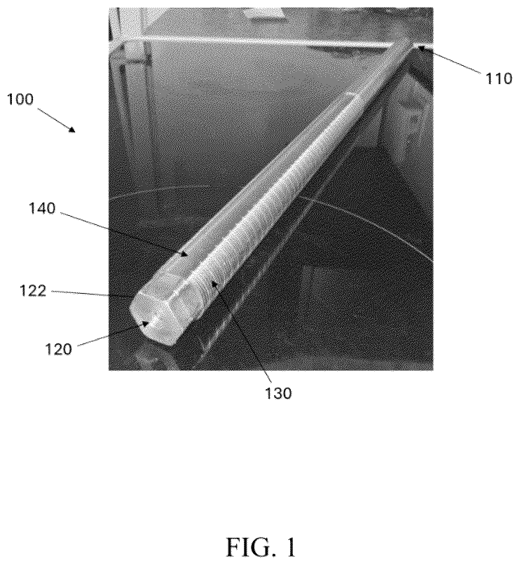

FIG. 1 illustrates a wheel centering apparatus 100. The wheel centering apparatus 100 may include a cylindrical body extending from a first end 110 to a second end 120. In some cases, the cylindrical body may be made of a corrosion-resistant material. For example, the cylindrical body may be constructed from stainless steel, aluminum alloy, or titanium alloy.

A threaded hole 112 may extend into the first end 110 of the wheel centering apparatus 100. The threaded hole 112 may be configured to engage with a wheel stud. In some cases, the threaded hole 112 may have a thread pitch that corresponds to the thread pitch of common wheel studs used in vehicles with dual tire configurations.

The wheel centering apparatus 100 may include a junction interface 122 extending from the second end 120. The junction interface 122 may have a non-circular cross-section. In some cases, the junction interface 122 may have a hexagonal cross-section configured to engage a socket. In other cases, the junction interface 122 may have an octagonal or square cross-section. The junction interface 122 may include a quick-release mechanism for rapid attachment and detachment of tools.

Circumferential markings 130 may be present along the cylindrical body of the wheel centering apparatus 100. These circumferential markings 130 may be dispersed longitudinally at equal intervals along the cylindrical body. In some cases, the circumferential markings 130 may be laser-etched and filled with high-contrast paint to enhance visibility.

The wheel centering apparatus 100 may include a planar side 140 extending from the first end 110 to the second end 120. The planar side 140 may be configured to provide a surface for resting a level. This feature may facilitate the use of the wheel centering apparatus 100 in conjunction with alignment tools.

In some cases, the wheel centering apparatus 100 may incorporate an adjustable length mechanism. This mechanism may include a telescoping feature or interchangeable sections, allowing the apparatus to accommodate various wheel and axle sizes. The adjustable length feature may enhance the versatility of the wheel centering apparatus 100 across different vehicle types and models.

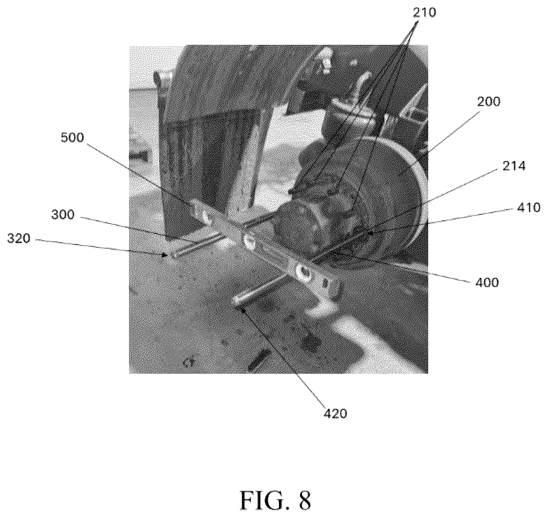

FIG. 7 depicts a perspective view of wheel centering apparatuses mounted on an axle 200. The axle 200 may include a front face 220 with wheel studs 210 arranged circumferentially around the front face 220. In some cases, the wheel studs 210 may be threaded protrusions extending perpendicularly from the front face 220 of the axle 200.

The wheel studs 210 may be configured to engage with the threaded hole of the wheel centering apparatus. In some cases, the thread pitch of the wheel studs 210 may correspond to the thread pitch of the threaded hole of the wheel centering apparatus.

A first wheel stud 212 and a second wheel stud 214 may be positioned on opposite circumferential sides of the axle 200. The first wheel stud 212 and the second wheel stud 214 may be selected from the wheel studs 210 for attaching the wheel centering apparatuses.

In some cases, the arrangement of the wheel studs 210 on the front face 220 may be symmetrical, allowing for balanced distribution of forces when wheels are mounted. The number and spacing of the wheel studs 210 may vary depending on the specific vehicle or axle configuration.

The front face 220 of the axle 200 may be a flat surface perpendicular to the axis of rotation of the axle 200. In some cases, the front face 220 may include a central hub area surrounded by the wheel studs 210.

The wheel centering apparatus may be attached to the first wheel stud 212 by engaging the threaded hole at the first end with the threads of the first wheel stud 212. Similarly, another wheel centering apparatus may be attached to the second wheel stud 214 on the opposite side of the axle 200.

When attached, the wheel centering apparatuses may extend perpendicularly from the front face 220 of the axle 200. The second end of each wheel centering apparatus, including the junction interface, may extend outward from the axle 200.

In some cases, the circumferential markings on the wheel centering apparatuses may be used in conjunction with the arrangement of the wheel studs 210 to assist in proper positioning and alignment of wheels on the axle 200.

The planar side of each wheel centering apparatus may be oriented in a specific direction relative to the arrangement of the wheel studs 210 to facilitate the use of alignment tools in conjunction with the axle 200 and wheel studs 210.

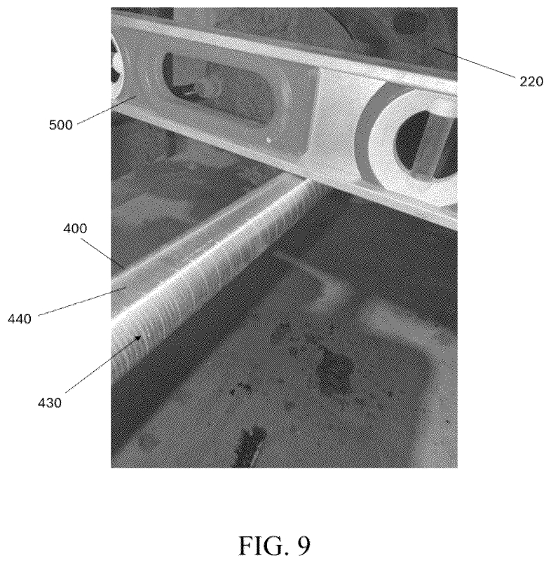

FIG. 8 depicts an orthogonal view of a wheel alignment setup using wheel centering apparatuses. The setup includes the axle 200 with the wheel studs 210 protruding from the front face 220. The first wheel centering apparatus 300 and the second wheel centering apparatus 400 are mounted on opposite sides of the axle 200, with the second wheel centering apparatus 400 specifically attached to the second wheel stud 214.

In some cases, a level 500 may be positioned across the wheel centering apparatuses to assist in alignment measurements. The level 500 may extend between the first wheel centering apparatus 300 and the second wheel centering apparatus 400, providing a reference for measuring the alignment between these components.

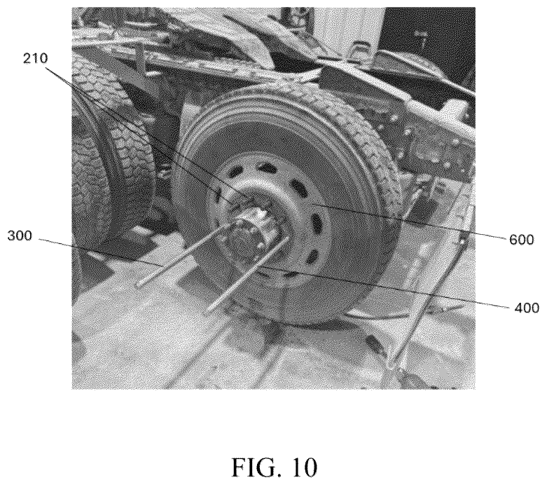

FIG. 9 shows a focused view of the level 500 being used in conjunction with the second wheel centering apparatus 400 during a wheel alignment procedure. The level 500 may be positioned to rest on a planar surface 440 of the second wheel centering apparatus 400. The planar surface 440 may correspond to the planar side of the wheel centering apparatus, extending from the first end to the second end.

A plurality of markings 430 may be visible along the length of the second wheel centering apparatus 400. These markings may correspond to the circumferential markings described earlier. The plurality of markings 430 may be used to verify the position of the level 500 relative to the front face 220 of the axle 200.

In some cases, the level 500 may be a digital level with a display showing current angle measurements. The digital level may include a wireless communication module for transmitting alignment data to an external device. A software application on the external device may be used for analyzing and displaying the alignment data.

The first wheel centering apparatus 300 and the second wheel centering apparatus 400 may be used in conjunction with the level 500 to adjust wheel camber and toe alignment. This adjustment may be performed prior to sliding an inner wheel onto the wheel centering apparatuses.

To attach the wheel centering apparatuses, the threaded hole at the first end of each apparatus may be engaged with the threads of the respective wheel stud. The junction interface at the second end of each wheel centering apparatus may be used to tighten or loosen the apparatus using a socket tool.

In some cases, the planar surface 440 of each wheel centering apparatus may be oriented in a specific direction to facilitate the use of the level 500. The plurality of markings 430 may assist in positioning the level 500 at consistent locations on both wheel centering apparatuses for accurate alignment measurements.

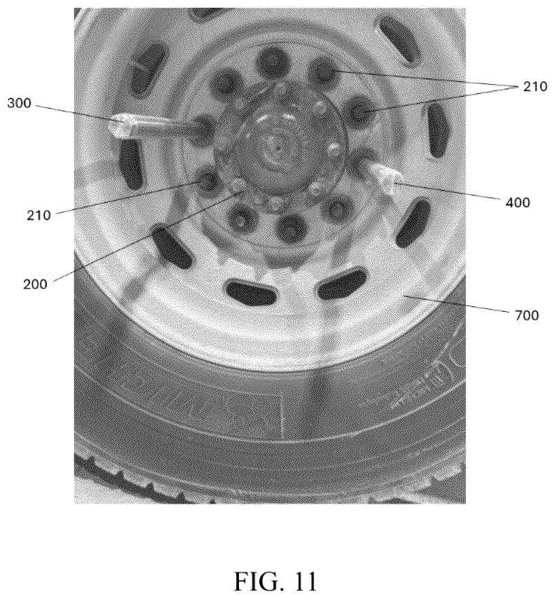

FIG. 10 depicts a perspective view showing the installation of an inner wheel 600 onto the axle 200. The inner wheel 600 may be centered with the axle 200 so that the first wheel centering apparatus 300 and the second wheel centering apparatus 400 are concentric with corresponding holes in the inner wheel 600. The inner wheel 600 may be slid across the first wheel centering apparatus 300 and the second wheel centering apparatus 400 until the inner wheel 600 abuts the front face 220 of the axle 200.

In some cases, the circumferential markings on the first wheel centering apparatus 300 and the second wheel centering apparatus 400 may be used to verify the position of the inner wheel 600 relative to the front face 220 of the axle 200.

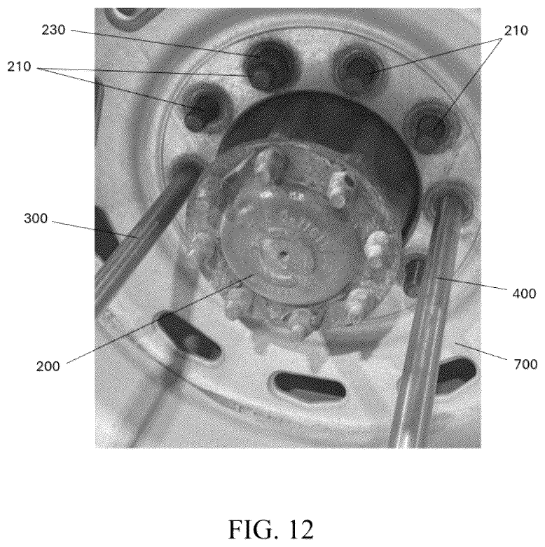

FIG. 11 shows a front view of a dual wheel setup mounted on the axle 200. An outer wheel 700 may be centered with the axle 200 in a similar manner as the inner wheel 600. The outer wheel 700 may be slid across the first wheel centering apparatus 300 and the second wheel centering apparatus 400 until the outer wheel 700 abuts the inner wheel 600.

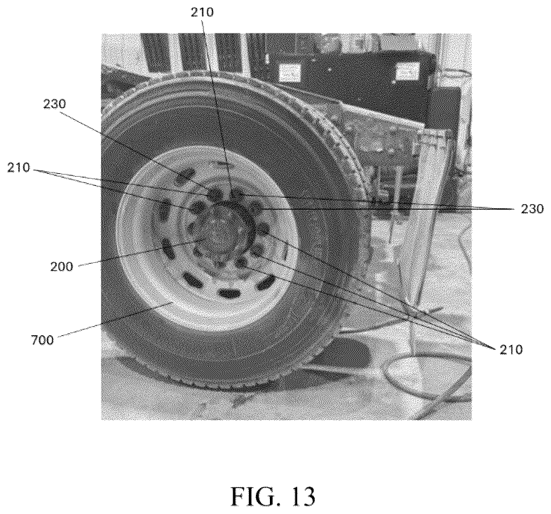

FIG. 12 illustrates a focused perspective view of the dual wheel setup on the axle 200. The first wheel centering apparatus 300 and the second wheel centering apparatus 400 may pass through corresponding holes in both the inner wheel 600 and the outer wheel 700, providing alignment and centering guidance.

In some cases, mounting bolts 230 may be used to partially secure the inner wheel 600 and the outer wheel 700 to the axle 200. The mounting bolts 230 may be installed on some of the wheel studs 210 while the first wheel centering apparatus 300 and the second wheel centering apparatus 400 remain in place.

After partially securing the inner wheel 600 and the outer wheel 700, the first wheel centering apparatus 300 and the second wheel centering apparatus 400 may be removed from the first wheel stud 212 and the second wheel stud 214, respectively. In some cases, a socket tool may be engaged with the junction interface at the second end of each wheel centering apparatus to facilitate removal.

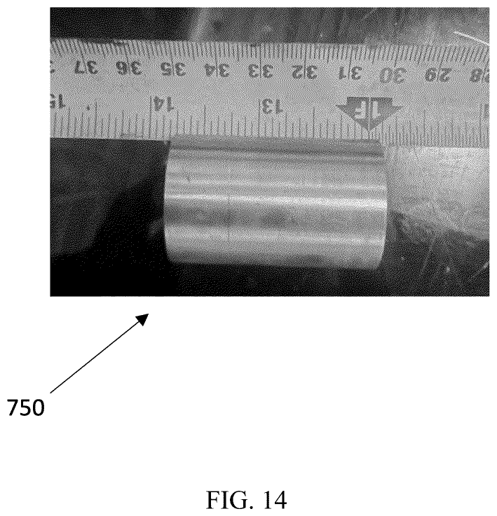

FIG. 13 shows an orthogonal view of the dual wheel assembly mounted on the axle 200 after the removal of the wheel centering apparatuses. The inner wheel 600 and the outer wheel 700 may be fully secured to the axle 200 by fastening mounting bolts 230 to the first wheel stud 212 and the second wheel stud 214, as well as the remaining wheel studs 210.

In some cases, the planar side of the first wheel centering apparatus 300 and the second wheel centering apparatus 400 may be used in conjunction with the level to perform final alignment checks before fully securing the inner wheel 600 and the outer wheel 700.

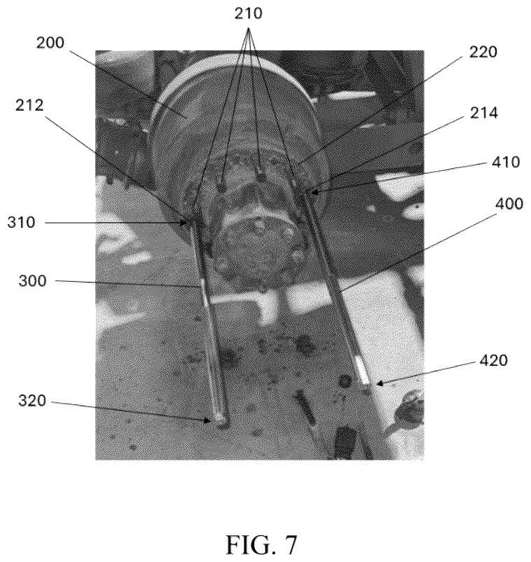

FIG. 6 illustrates a method 800 for centering dual tire configurations onto an axle. The method 800 may include several steps for properly aligning and securing both an inner wheel and an outer wheel onto the axle.

In some cases, the method 800 may begin with step 810, which involves attaching a first wheel centering apparatus to a first wheel stud of the axle. The first wheel centering apparatus may be attached by threading the threaded hole at the first end of the first wheel centering apparatus onto the threads of the first wheel stud.

Step 820 of the method 800 may involve attaching a second wheel centering apparatus to a second wheel stud of the axle. The second wheel stud may be positioned on an opposite circumferential side of the axle from the first wheel stud. Similar to the first wheel centering apparatus, the second wheel centering apparatus may be attached by threading the threaded hole at the first end of the second wheel centering apparatus onto the threads of the second wheel stud.

In step 825, the alignment process is carried out by levelling the unit, pulling off all the tires or designated tires and installing the alignment centering tools, two on each axle hub on same side of unit as alignment tools must be opposite one another on hub studs. Once tools are in place, laser level on the wall in front or behind unit shining down the side overtop of the wheel/centering tools. Using the indicator bars that are every 1/16th inch, move the axles around so the marks all line up on the same indicator marks on each axle, while doing this also perform caster, camber, and all things necessary for wheel alignment. Once the wheel alignment is done, put the wheels back on over the alignment tools. If just one wheel (front/steer axle) is being aligned, once in place snug at least two wheel nuts and pull the tools out. On other axles with dual or more tires/wheels, install over the alignment tools one after the other, then snug the nuts, pull tools out, torque all the nuts, and set unit back on ground.

In some cases, step 830 of the method 800 may involve centering the inner wheel with the axle. This may be accomplished by aligning the inner wheel so that the first wheel centering apparatus and the second wheel centering apparatus are concentric with corresponding holes in the inner wheel.

Step 840 of the method 800 may involve sliding the inner wheel across the first wheel centering apparatus and the second wheel centering apparatus. The inner wheel may be slid until the inner wheel abuts the front face of the axle.

Following the positioning of the inner wheel, step 850 of the method 800 may involve centering the outer wheel with the axle. This may be accomplished in a similar manner as centering the inner wheel, by aligning the outer wheel so that the first wheel centering apparatus and the second wheel centering apparatus are concentric with corresponding holes in the outer wheel.

Step 860 of the method 800 may involve sliding the outer wheel across the first wheel centering apparatus and the second wheel centering apparatus. The outer wheel may be slid until the outer wheel abuts the inner wheel.

In some cases, step 870 of the method 800 may involve partially securing the inner wheel and the outer wheel to the axle. This may be accomplished by installing mounting bolts on some of the wheel studs while the first wheel centering apparatus and the second wheel centering apparatus remain in place.

Step 880 of the method 800 may involve removing the first wheel centering apparatus and the second wheel centering apparatus. In some cases, removing the first wheel centering apparatus and the second wheel centering apparatus may comprise engaging the junction interface at the second end of each wheel centering apparatus with a socket tool to unthread the wheel centering apparatuses from their respective wheel studs.

The final step 890 of the method 800 may involve fully securing the inner wheel and the outer wheel to the axle. This may be accomplished by fastening mounting bolts to the first wheel stud and the second wheel stud, as well as any remaining wheel studs.

In some cases, the method 800 may include using the level in conjunction with the first wheel centering apparatus and the second wheel centering apparatus to adjust axles, wheel caster and camber, and toe alignment using indicators prior to sliding the inner wheel onto the first wheel centering apparatus and the second wheel centering apparatus. The planar side of each wheel centering apparatus may provide a surface for resting the level during these alignment procedures.

The wheel centering apparatus may interact with various components to facilitate the centering and alignment of dual wheels on an axle. FIG. 7 illustrates the initial setup, where two wheel centering apparatuses may be attached to opposite wheel studs 210 on the axle 200. The threaded hole at the first end of each wheel centering apparatus may engage with the threads of the respective wheel stud 210, securing the apparatus in place.

In some cases, the system may include two wheel centering apparatuses, each having an adjustable length mechanism to accommodate various wheel sizes. This adjustable feature may allow the apparatuses to be used with different vehicle models and wheel configurations.

FIG. 8 depicts how the wheel centering apparatuses may be used in conjunction with a level 500 for alignment purposes. The level 500 may rest on the planar surface of each wheel centering apparatus, providing a reference for measuring and adjusting wheel camber and toe alignment. The circumferential markings on the wheel centering apparatuses may assist in precise positioning of the level 500 and consistent measurements across both apparatuses.

As shown in FIG. 11, the inner wheel and outer wheel may be centered on the axle 200 using the wheel centering apparatuses. The wheel centering apparatuses may extend through corresponding holes in both wheels, ensuring proper alignment and concentricity with the axle 200. The adjustable length mechanism of each wheel centering apparatus may be utilized to accommodate the combined thickness of the inner wheel and outer wheel.

FIG. 13 illustrates the final configuration after the wheel centering apparatuses have been removed. The mounting bolts 230 may secure both the inner wheel and outer wheel to the axle 200 via the wheel studs 210. The centering process facilitated by the wheel centering apparatuses may result in properly aligned and centered dual wheels.

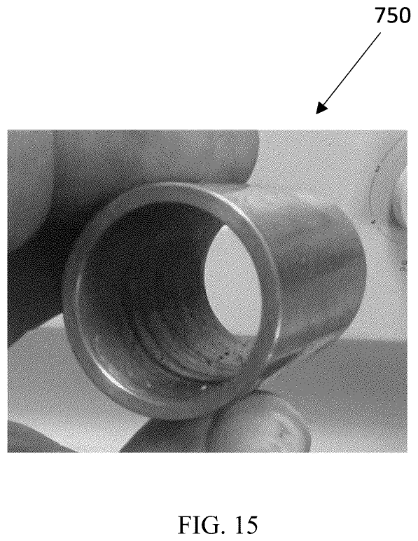

As shown in FIGS. 14, 15, and 20, a sleeve 750 for a wheel centering apparatus may be utilized and configured to engage with a first end 920 of a wheel centering apparatus. The sleeve 750 may be used to reinforce a wheel centering apparatus. A wheel centering apparatus sleeve 750 improves efficiency of preparation, installation, and removal of the wheel centering apparatus, and can significantly decrease overall costs associated with production and implementation of the wheel centering apparatuses.

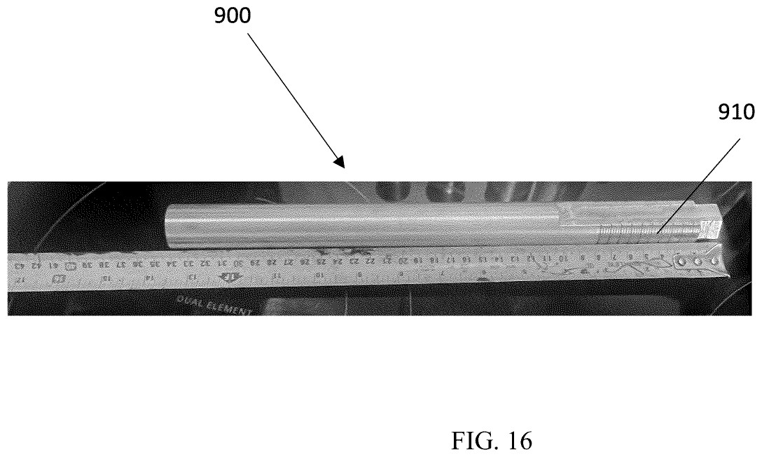

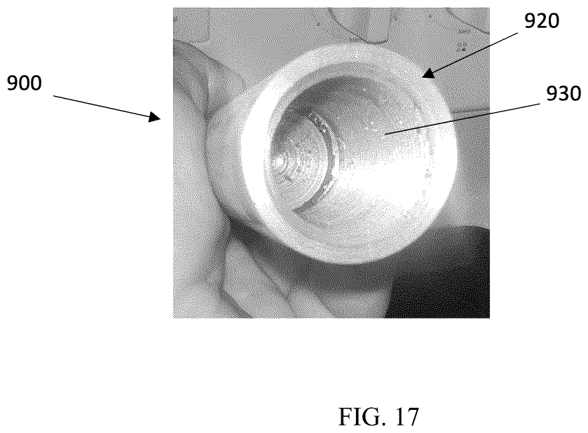

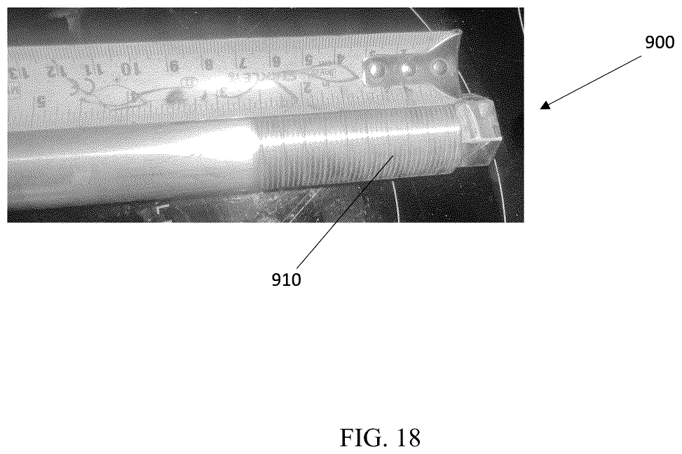

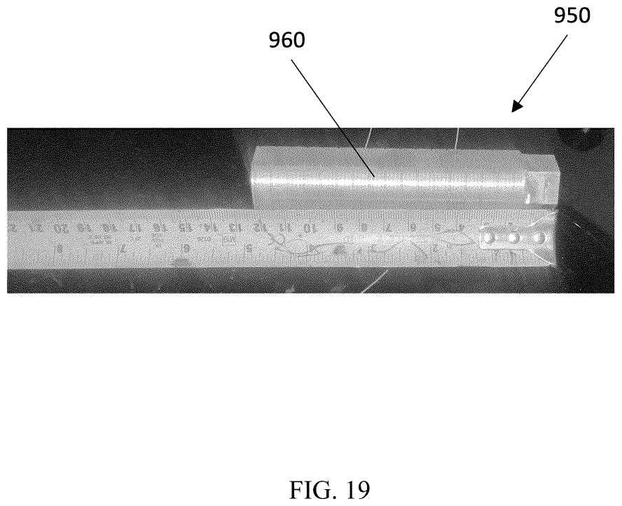

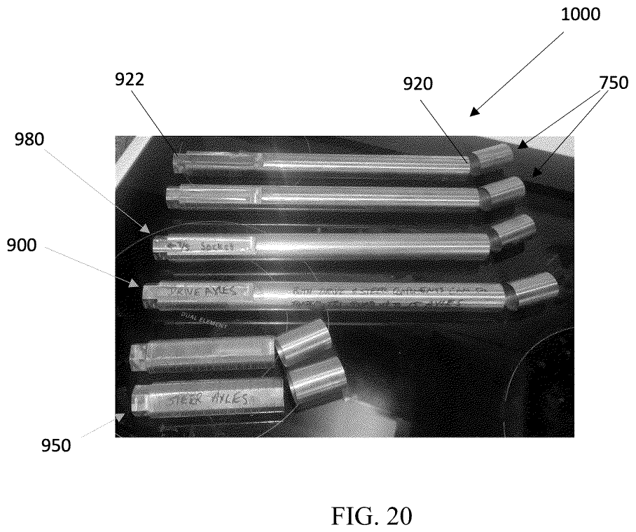

Further exemplary embodiments of the wheel centering apparatuses are shown in FIGS. 16 to 20. As shown in FIG. 16, a wheel centering apparatus may be configured to engage a drive axle. As shown in FIGS. 16 and 18, indicator lines 910 on the second end of a drive axle wheel centering apparatus 900 may be configured at every 1/16^{th} of an inch. As shown in FIG. 17, threaded lines for a wheel stud may be configured within a threaded hole 930 at a first end 920 of the drive axle wheel centering apparatus 900. The threaded hole at the first end 920 of the drive axle wheel centering apparatus 900 may engage with the threads of a wheel stud. The drive axle wheel centering apparatus 900 may be configured with a junction interface with a hexagonal cross-section at a second end 922, as shown in FIG. 20. As shown in FIG. 19, a further embodiment of a wheel centering apparatus may be configured to engage a steering axle. Indicator length and width lines 960 on a steering axle wheel centering apparatus 950 may also be configured every 1/16^{th} of an inch. FIG. 20 shows a complete set of various embodiments of wheel centering apparatus tools, including a drive axle wheel centering apparatus 900 and a steering axle wheel centering apparatus 950. A further embodiment of a wheel centering apparatus may be a ⅞-inch socket wheel centering apparatus 980, configured to engage a ⅞-inch socket, as shown in FIG. 20.

In some cases, the interaction between the wheel centering apparatuses, axle 200, wheels, and alignment tools may create a synergistic effect. The precise positioning enabled by the wheel centering apparatuses may enhance the accuracy of alignment measurements taken with the level 500. The adjustable length mechanism of the wheel centering apparatuses may allow for fine-tuning of wheel positioning, potentially improving overall alignment and reducing the need for additional adjustments after wheel installation.

The method of using the wheel centering apparatuses may involve a series of steps that leverage the interaction between these components. The wheel centering apparatuses may first be attached to the wheel studs 210, followed by alignment checks using the level 500. The inner wheel and outer wheel may then be slid onto the wheel centering apparatuses, with the adjustable length mechanism potentially being used to accommodate the specific wheel sizes. After partial securing of the wheels, the wheel centering apparatuses may be removed, allowing for final tightening of the mounting bolts 230.

Embodiments of the present invention may be implemented in various industries to improve wheel centering and alignment processes, thereby enhancing safety, efficiency, and performance across multiple applications. In the automotive sector, embodiments of the dual wheel-centering apparatus may streamline maintenance procedures for trucks and heavy-duty vehicles, reducing downtime and improving overall fleet operations. The precise alignment capabilities offered by this invention may lead to improved fuel efficiency, extended tire life, and enhanced vehicle handling, resulting in significant cost savings for transportation companies.

In the aerospace industry, embodiments of the wheel centering apparatus may be adapted for use in aircraft maintenance, ensuring precise alignment of landing gear wheels. This application could potentially improve aircraft safety, reduce maintenance time, and optimize tire wear patterns, leading to more efficient operations for airlines and aircraft manufacturers.

The versatility of embodiments of the present invention may extend to the construction and mining industries, where they may be employed to align wheels on large earth-moving equipment and haul trucks. By ensuring proper wheel alignment on these massive vehicles, the apparatus may contribute to improved operator safety, reduced equipment wear, and increased productivity in challenging work environments.

Furthermore, embodiments of the wheel centering apparatus may find applications in agricultural machinery, enhancing the performance and efficiency of tractors and harvesters. Proper wheel alignment in these vehicles may lead to reduced soil compaction, improved traction, and more precise field operations, ultimately contributing to increased crop yields and sustainable farming practices.

In the manufacturing sector, embodiments of the dual wheel-centering apparatus may significantly improve quality control processes for vehicles and machinery equipped with dual wheel configurations. By ensuring precise alignment during assembly, manufacturers may reduce the likelihood of alignment-related issues in finished products, potentially decreasing warranty claims and improving customer satisfaction. The apparatus may also streamline production lines by reducing the time and labor required for wheel alignment procedures.

Embodiments of the invention may potentially be used in the military and defense sectors, where it may be applied to various wheeled vehicles, from tactical trucks to armored personnel carriers. Proper wheel alignment in these vehicles is crucial for maintaining mobility and operational readiness in diverse and challenging environments. Embodiments of the wheel centering apparatus could contribute to improved vehicle performance, reduced maintenance requirements, and enhanced troop safety during missions.

In the realm of public transportation, embodiments of the dual wheel-centering apparatus may be utilized in the maintenance of buses and coaches. By facilitating precise wheel alignment, embodiments of the present invention may contribute to improved fuel efficiency, reduced tire wear, and enhanced passenger comfort. This could result in cost savings for transit authorities and improved service quality for commuters.

The racing industry, particularly in endurance racing and off-road competitions, could benefit from embodiments of the wheel centering apparatus. In these high-performance applications, precise wheel alignment is critical for optimal handling, tire wear management, and overall vehicle performance. The ability to quickly and accurately align wheels during pit stops or between race stages could provide a competitive advantage to racing teams.

Lastly, embodiments of the present invention have potential applications in the emerging field of autonomous vehicles. As these vehicles rely heavily on precise sensor data for navigation and decision-making, ensuring proper wheel alignment is crucial for maintaining accurate positioning and control. Embodiments of the wheel centering apparatus could play a role in the maintenance and calibration processes for autonomous vehicle fleets, contributing to their safe and efficient operation.

In conclusion, embodiments of the dual wheel-centering apparatus and method present a versatile solution with wide-ranging applications across multiple industries. By improving wheel alignment processes, embodiments of the present invention have the potential to enhance safety, efficiency, and performance in various vehicles and machinery, ultimately contributing to advancements in transportation, agriculture, construction, and beyond.

Various embodiments of the invention have been described in detail. The present invention may be embodied in other specific forms without departing from the essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description and all changes which come within the meaning and range of equivalency of the claims are therefore intended to be embraced therein.

1. A wheel centering apparatus and sleeve comprising:
a cylindrical body extending from a first end to a second end;
a threaded hole extending into the first end, configured to engage with a wheel stud;
a junction interface extending from the second end, having a non-circular cross-section;
longitudinal markings along the cylindrical body; and
a sleeve configured to engage the first end of the wheel centering apparatus.

2. The wheel centering apparatus of claim 1, wherein the junction interface has a hexagonal cross-section configured to engage a socket.

3. The wheel centering apparatus of claim 1, wherein the longitudinal markings are dispersed at equal intervals along the cylindrical body.

4. The wheel centering apparatus of claim 1, further comprising a planar side extending from the first end to the second end.

5. The wheel centering apparatus of claim 4, wherein the planar side is configured to provide a surface for resting a level.

6. The wheel centering apparatus of claim 1, wherein the cylindrical body is made of a corrosion-resistant material.

7. The wheel centering apparatus of claim 6, wherein the corrosion-resistant material is stainless steel.

8. A method of centering dual wheels on an axle, comprising:
attaching a first wheel centering apparatus to a first wheel stud and a second wheel centering apparatus to a second wheel stud on opposite sides of a wheel hub;
sliding an inner wheel onto the first and second wheel centering apparatuses;
sliding an outer wheel onto the first and second wheel centering apparatuses; and
partially securing the inner and outer wheels before removing the first and second wheel centering apparatuses.

9. The method of claim 8, further comprising using the first and second wheel centering apparatuses in conjunction with a level to adjust wheel camber and toe alignment prior to sliding the inner wheel onto the first and second wheel centering apparatuses.

10. The method of claim 9, wherein the level is an integrated digital level within each of the first and second wheel centering apparatuses.

11. The method of claim 10, wherein the integrated digital level includes a wireless communication module for transmitting alignment data to an external device.

12. The method of claim 8, wherein attaching the first and second wheel centering apparatuses comprises threading each apparatus onto its respective wheel stud.

13. The method of claim 8, further comprising, after partially securing the inner and outer wheels:
removing the first and second wheel centering apparatuses; and
fully securing the inner and outer wheels by fastening bolts to the first and second wheel studs.

14. The method of claim 13, wherein the first and second wheel centering apparatuses each comprise a junction interface with a hexagonal cross-section, and wherein removing the first and second wheel centering apparatuses comprises engaging the junction interface with a socket tool.

15. A system for aligning dual wheels comprising:
two wheel centering and sleeve apparatuses, each having a cylindrical body with longitudinal markings, a threaded hole at a first end, a junction interface with a non-circular cross-section at a second end, and sleeves configured to engage the first end; and
a level configured to rest on the two wheel centering apparatuses when installed on wheel studs.

16. The system of claim 15, wherein each wheel centering apparatus further comprises a planar side extending from the first end to the second end, configured to provide a surface for resting the level.

17. The system of claim 16, wherein the level is a digital level with a display showing a current angle measurement.

18. The system of claim 17, wherein the digital level includes a wireless communication module for transmitting alignment data to an external device.

19. The system of claim 18, further comprising a software application on the external device for analyzing and displaying the alignment data.

20. The system of claim 19, wherein each wheel centering apparatus includes an adjustable length mechanism to accommodate various wheel sizes.
